(19) United States
(12) Patent Application Publication
(10) Pub. No.: US 2011/0022503 A1
(43) Pub. Date: Jan. 27, 2011

(54) MOBILE BUSINESS SYSTEM

(75) Inventor: Rodney Parker-Yules, Erskineville (AU)

Correspondence Address: CALFEE HALTER & GRISWOLD, LLP, 800 SUPERIOR AVENUE, SUITE 1400, CLEVELAND, OH, 44114, US

(73) Assignees: Rodney Parker-Yules, Erskineville (AU); Siobhan O'Loughlin, Erskineville (AU)

(21) Appl. No.: 12/863,210

(22) PCT Filed: Jan. 16, 2009
(86) PCT No.: PCT/AU09/00055

§ 371 Date: Oct. 12, 2010

(30) Foreign Application Priority Data
Jan. 18, 2008 (AU) 2008900254

(51) Int. Cl. G06Q 10/00; G06Q 40/00; G06Q 20/00

(52) U.S. Cl. 705/32; 705/44

(57) ABSTRACT

The present invention concerns business management. In one aspect, the invention is a mobile business system comprising a database to record one or more mobile workers, where each mobile worker is associated with one or more jobs. The system may comprises a server in communication with a mobile communication device associated with a mobile worker and be operable to receive encrypted payment information associated with a job from the mobile communication device and decrypt the received encrypted payment information and based on the decrypted payment information, request approval of payment from an external server. And, if approval is received, the system may automatically update an accounting system associated the mobile worker with the payment to reflect the approved payment, update status of the job associated with the payment information in the database and send a payment confirmation message to the mobile communication device. In other aspects, the invention is a computer program to implement the system, a method operating at a server to facilitate a mobile business, and a method operating at a mobile communication device to facilitate a mobile business.

### CROSS-REFERENCE TO RELATED APPLICATIONS

The present application is the U.S. national phase entry of PCT/AU2009/000055 with an international filing date of Jan. 16, 2009, which claims priority from Australian Provisional Patent Application No 2008900254 filed on 18 Jan. 2008, the content of which is incorporated herein by reference.

### TECHNICAL FIELD

This invention concerns business management, and in particular a mobile business system, computer program to implement the system, a method operating at a server to facilitate a mobile business, and a method operating at a mobile communication device to facilitate a mobile business.

### BACKGROUND ART

Many sole traders and Small to Medium Enterprise (SME) operators, and large businesses earn their income through provision of goods and services at their customer's location via a mobile workforce. Most sole traders typically run a business from a home office, and contract to provide goods and services such as plumbing, electrical, lawn mowing, car care, pet care, paving, gardening, cleaning, and a broad range of similar services. Approximately 60% of Australian businesses, that is around 1.5 million, are sole traders. This percentage is understood to be typical for most countries around the world.

SMEs employ from 2 to 100 employees, and typically count for 20 to 25% of the total number of businesses in most countries. Most SMEs began as individuals who started a family business from a home office, and provide goods and services similar to sole traders. The estimated number of SMEs in Australia is 500,000. For example, a small plumbing business may run from a home office, or a small business outlet, and employ a number of trade persons and apprentices to provide services to the customers. Administration staff may also be employed, but are often family members, relatives or friends, who run the office, take calls, book jobs, allocate jobs, collect and administer the paperwork when the trades people come back to the office, and look after all administration and accounting.

Large businesses are those that employ more than 100 employees, and they usually make up less than 15% of the total number of businesses in most countries. They sometimes provide similar services to the smaller businesses, but they are more likely to provide slightly different services such as building, IT, asset maintenance or supply of other goods or services.

### SUMMARY OF THE INVENTION

In a first aspect, the invention is a mobile business system comprising:
a database to record one or more mobile workers, where each mobile worker is associated with one or more jobs;
a server in communication with a mobile communication device associated with a mobile worker and operable to:
receive encrypted payment information associated with a job from the mobile communication device;
decrypt the received encrypted payment information and based on the decrypted payment information, request approval of payment from an external server;
and if approval is received, automatically update an accounting system associated with the mobile worker with the payment to reflect the approved payment, update status of the job associated with the payment information in the database and send a payment confirmation message to the mobile communication device.

The payment information of a debit or credit card may be encrypted by a mobile payment terminal before it is received. The payment information may include a card number of the debit or credit card that is not stored by the server when requesting approval from the external server.

The mobile payment terminal may be integrated with the mobile communication device. Alternatively, the mobile payment terminal may be in wireless communication with the mobile communication device, and both the mobile payment terminal and the mobile communication device are running an encryption session when the encrypted payment information is sent from the mobile payment terminal to the mobile communication device.

The server may update the accounting system with the payment by determining a payment amount from the decrypted payment information and recording the payment amount in a cashbook associated with the mobile worker.

The server may be operable to receive information identifying a job associated with the payment information from the mobile communication device, and if approval is received from the external server, to update the status of the job in the database based on the received information.

The database may further store one or more diaries that are each associated with a mobile worker, and the server is further operable to provide an interface to add a job to a diary associated with a mobile worker.

The server may be further operable to access details of a job, and based on the details and user-determined search criteria, to automatically search a diary of one or more mobile workers to find a mobile worker who satisfies the user-determined search criteria. The user-determined search criteria may comprise one or more of:
availability of a mobile worker;
skill level of a mobile worker and nature of the job;
location of a customer associated with the job;
location of a mobile worker; and
previous experience of a mobile worker with a customer associated with the job.

When a job is added to the diary associated with a mobile worker, the server may be operable to send a message to the mobile communication device associated with the mobile worker to either accept or reject the job. The details of a job may be automatically extracted by the server from an electronic message from a customer.

The server may be further operable to calculate an estimated cost for a job based on details of that job and jobs recorded in the database.

The server may be further operable to:
provide an interface for a mobile worker to enter one or more of the following information: start time, end time and expenses incurred for a job; and
based on the entered information, automatically calculate a payment amount and prepare an invoice for that payment amount.

The server may be further operable to record expenses associated with a job, and business overheads in the accounting system.

The server may be further operable to perform scheduled checks on the accounting system associated with one or more mobile workers to ensure that jobs have been paid.

The server may also be operable to send a reminder message about a job at a specified date and time to the mobile communication device of a mobile worker, or to a computer associated with a customer.

Further, the server may be operable to provide a vehicle log book interface for a mobile worker to enter and update an odometer reading.

The server may provide an interface to download data from the database and/or the accounting system associated with a mobile worker to third-party accounting or customer relationship management software.

When the approval for a payment is received, the server may be further operable to automatically prepare and send a receipt for that payment to a customer.

The server may also decrypt the received encrypted payment information behind a secure firewall to protect a card number of the debit or credit card.

In a second aspect, the invention is a computer program that implements the exemplary systems described above.

In a third aspect, the invention is a method of facilitating a mobile business, wherein plural mobile communication devices are each associated with a mobile worker, the method comprising:
receiving encrypted payment information associated with a job from a mobile communication device of a mobile worker;
decrypting the received encrypted payment information and based on the decrypted payment information, requesting approval of payment;
and if approval is received, automatically updating an accounting system associated with the mobile worker with the payment to reflect the approved payment, updating status of the job associated with the payment information in a database and sending a payment confirmation message to the mobile communication device.

In a fourth aspect, the invention is a method operating at a mobile communication device to facilitate a mobile business, wherein the mobile communication device is associated with a mobile worker and in communication with a server, the method comprising:
receiving encrypted payment information from a mobile payment terminal associated with the mobile communication device;
sending the encrypted payment information and information identifying a job associated with the encrypted payment information to a server for approval of payment;
and if approved, receiving and displaying a payment confirmation message that the payment has been approved and an accounting system associated with the mobile worker is updated with the payment to reflect the approved payment.

In one or more embodiments, the invention provides a single interface for trade job management, accounting and secure payment functionality. The invention enables a mobile worker to use a mobile communication device to access details of jobs, collect payment when a job is completed and record accounting information. By processing debit or credit payments on the spot after a job is performed, the invention also helps users to improve cash flows and reduce the risk associated with carrying large sums of cash.

In one or more embodiments, the invention caters for both credit and debit payments, and when payment is approved, automatically allocates the funds collected against the job and performs the required accounting, reconciliation. The invention manages the job from first point of contact, through to the collection of payment, the accounting of the funds collected and reconciliation of all accounts and customer records. Advantageously, this provides the mobile worker and/or business owner with accurate up-to-date information on past and current jobs, regardless of whether they are in the office or on the road.

### BRIEF DESCRIPTION OF DRAWINGS

Non-limiting examples of the invention will now be described with reference to the accompanying drawings, in which:

FIG. 1 is a block diagram of a mobile business system exemplifying the invention.

FIG. 2 is a block diagram of the central server in FIG. 1 in more detail.

FIG. 3 is an exemplary workflow of the invention when in use.

### DISCLOSURE OF THE INVENTION

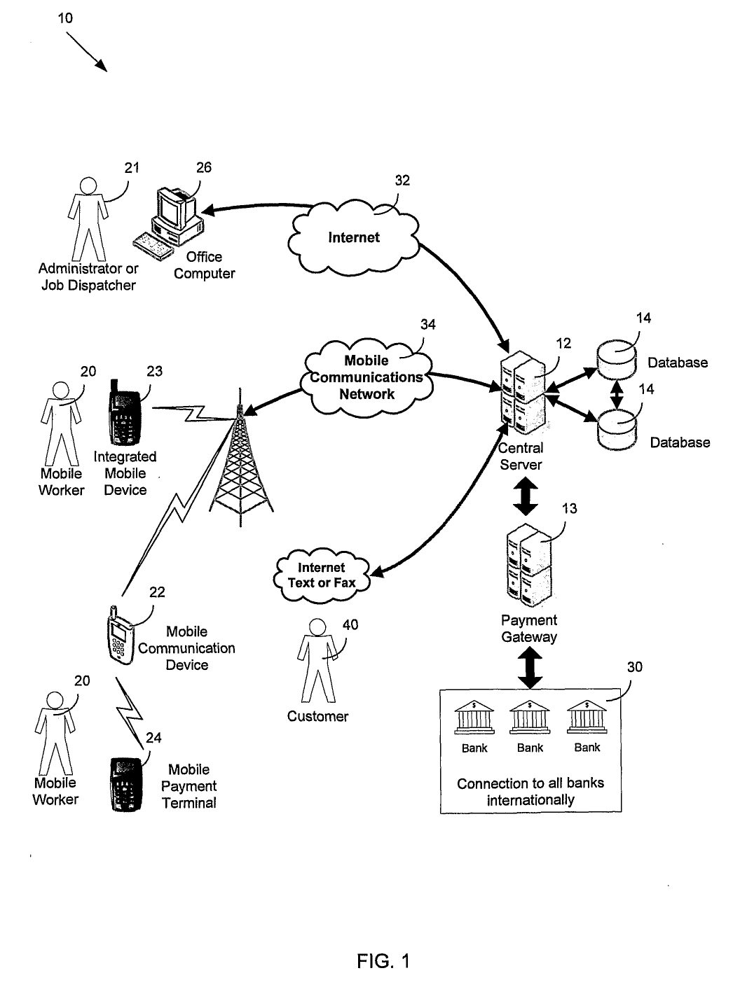

Referring first to FIG. 1, the mobile business system 10 comprises a central server 12, a secure payment gateway 13, a database 14 in communication with a plurality of mobile communication devices 22, mobile payment terminals 24, computers 26 and financial institutions 30 over the Internet 32 and a mobile communication network 34. The mobile communication network 34 may be a General Packet Radio Service (GPRS) network, or a third generation network employing Wideband Code Division Multiple Access (WCDMA) or Code Division Multiple Access 2000 (CDMA2000).

The mobile business system 10 is based on an Application Service Provider (ASP) service over a network, which makes it easier for users to run a small business anywhere and at any time. The central server 12 provides a web interface for mobile workers 20 the central server 12 using their mobile communication device 22 while the mobile workers 20 are travelling from customer 40 to customer 40 to provide services. Similarly, other non-mobile workers such as a job dispatcher or administrator 21 at the office are able to access the same functionality provided by the central server 12 via the Internet 32.

To facilitate mobile business transactions, each mobile worker 20 (only one is shown here for simplicity) is associated with a mobile communication device 22 and a mobile payment terminals 24. The mobile payment terminal 24 is an Electronic Transfer of Funds at Point of Sale (EFTPOS) terminal that is operable to encrypt payment information of a debit or credit card and send the encrypted payment information to the mobile communication device 22 using wireless protocol such as Bluetooth. The mobile payment terminal 24 may also communicate directly with the central server 12 over the mobile communications network 34. Both means of communication utilise a Secure Socket Layer (SSL) or similar encryption system to protect transfers of data.

The mobile communication device 22, such as a mobile phone or PDA, provides the mobile worker 20 with a web interface to access the central server 12 when they are on the road, just as their computer 26 does from their office. The mobile communication device 22 is operable to receive the encrypted payment information from a mobile payment terminal 24 and automatically send the encrypted payment information to the central server 12.

In another example shown in FIG. 1, the mobile payment terminal 24 may be integrated with the mobile communication device 22 to foam a mobile device 23 with combined functionality to encrypt payment information and to send the encrypted payment information to the central server 12. Whether the mobile payment terminal 24 and the mobile communication device 22 are separate devices or a single device that performs independent tasks or functions, they are designed to according to the Eurocard MasterCard Visa (EMV) and Payment Card Industry (PCI) data security standards (DSS).

The database 14 records one or more mobile workers 20, users 21, and customers 40. Each mobile worker 20 is associated with a diary to record one or more jobs, and an accounting system comprising a cashbook to record payments, expenses and overheads while conducting mobile business transactions. When payment for a job is approved by the financial institution 30, the central server 12 is operable to automatically update the accounting system with the payment to reflect the approved payment and update the status of the job in the database 14.

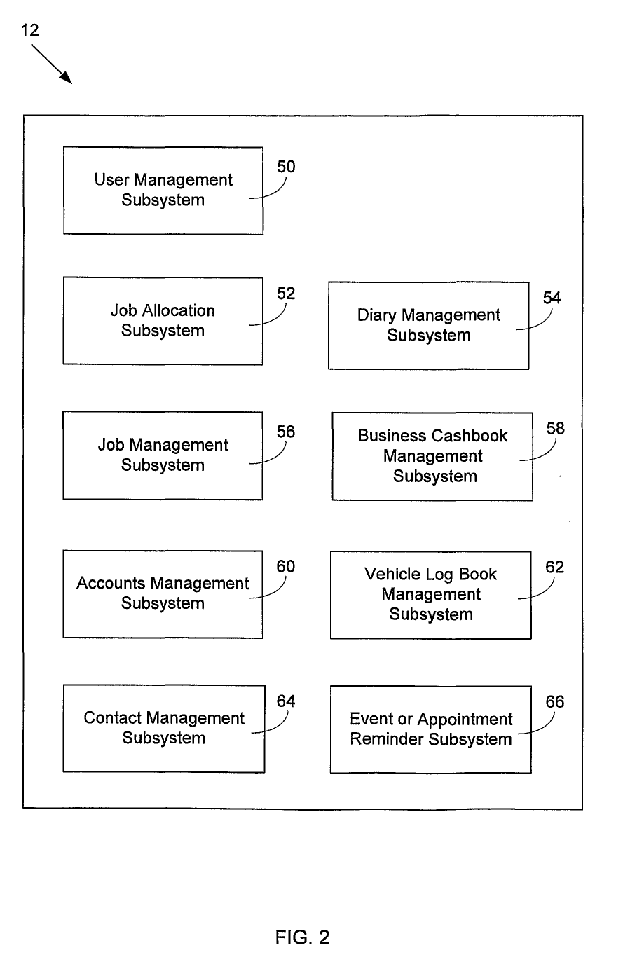

The functionality provided by the central server 12 will be now be explained with reference to FIG. 2.

User Management Subsystem 50

The user management subsystem 50 provides a web interface to set up a mobile business account with the central server 12. When an account is initially set up, the account may be configured as a single-user or multi-user account. Each account with the central server 12 can be configured to allow various categories of authorised users to manage job schedules, accounts, workflows, contacts, suppliers and customers 40.

An authorised user of the system 10 may be a mobile worker 20, or a job dispatcher or administrator 21 who dispatches jobs and manages other aspects of a mobile worker's 20 job. The administrator 21 is usually responsible for setting up additional user accounts and maintaining them. In the case of a sole trader, the mobile worker 20 could fulfil the roles of a job scheduler or administrator 21. Alternatively, job scheduling and accounts are done by their partner or family member whilst the mobile worker 20 focuses on completing each job. In this case, the user account will be configured to perform multiple roles.

In the case of a multi-user account, the account could be accessed by multiple mobile workers and administration staff, depending on the organisation and number of staff. Each user will have access to specific information depending on the permissions that have been set for that user. For example, an account may be set up to be accessible by job dispatcher, accounts keeping personnel, job supervisors and mobile workers or tradespersons.

The job dispatcher 21 will require access to an accounting system associated with one or more mobile workers 20 and third party accounting or customer relationship management (CRM) software. The job dispatcher 21 may also be responsible for downloading the required data into accounting or CRM systems such as MYOB, or Quick Books, or NetSuite, or Sales Force at predetermined reporting intervals.

Job Allocation Subsystem 52

The Job Allocation Subsystem 52 at the central server 12 provides a web interface for a job dispatcher or administrator 21 to receive job bookings and dispatch them to the mobile workers 20 via their mobile communication device 22.

In a small business, the job dispatcher 21 may also be an internal bookkeeper. The job dispatcher 21 will therefore require access to the diary, and therefore jobs scheduled in the diary, associated with all mobile workers 20.

In a medium to large enterprise, a supervisor who plays the role of a job dispatcher only needs to manage the diary for each of the mobile workers 20 on the road, move a job from one mobile worker 20 to another, or re-schedule a job for another day via their office computer 26. Each mobile worker 20 will be able to see jobs scheduled in their diary. They can start a job (by entering its start time), delete a job, re-schedule a job and block time in their diary via their mobile communication device 22, or from a computer browser interface 26 at home or in the office.

A job booking may be received from a customer 40 in the form of an online booking or a text message. In this case, the job allocation subsystem 52 automatically extracts information from the online booking or text message to create a job record in the database 14. Otherwise, if a job booking is received via a phone call or facsimile, a staff 21 at the office or the mobile worker 20 has to manually type in the information provided to create a job record. A job record is created in the database 14 to store the contact details of the customer 40, the nature of the job required, the timing requirement of the job (urgent or non-urgent), the booking time (flexible or non-flexible), job status (completed or pending), and payment status (paid or unpaid).

The Job Allocation Subsystem 52 provides two types of job allocation:
manual allocation, which requires a job dispatcher 21 to access the diary of one or more mobile workers 20 in order to check their availability and to assign jobs; and
automated allocation, in which case the central server 12 determines a list of mobile workers 20 who satisfy some user-determined search criteria to take the job booking and the job dispatcher 21 selects a mobile worker 20 from the list.

In the case of automated allocation, the Job Allocation Subsystem 52 can be configured to select a mobile worker 20 for a job booking based on one or more of the following user-determined search criteria:
availability, that is whether there is an empty time slot in a diary associated with the mobile worker 20 for the job;
skill level, that is whether the mobile worker 20 has the required skills and experience to take up the job;
location of the customer 40, that is whether the mobile worker 20 services the location, or is the closest to that location at the time of the booking; and
previous experience with the customer 40, that is whether the mobile worker 20 has any bad experience with the customer 40 (in which case another mobile worker 20 should be selected), or otherwise good experience (in which case the same mobile worker 20 is selected to build on existing customer relationship).

Of course, automated allocation is more suitable for medium to large enterprises who employ many mobile workers 20. In this case, the skills of each mobile worker 20 is stored in the database 14, and updated every time the mobile worker 20 completes a job. The location of a mobile worker 20 at a point in time can be determined using a Global Positioning System (GPS), or estimated from the location of a customer 40 who the mobile worker 20 is, or has completed, servicing.

As a job is scheduled, the central server 12 will send a message to the mobile communication device 22 associated with a mobile worker 20. The message contains details such as the nature of the booking, the customer, the location as well as reply buttons to either accept or reject the job booking via the mobile communication device 22. If the job booking is rejected, the central server 12 will automatically notify the job dispatcher 21 who may immediately locate another mobile worker 20, notify the customer 40 or take other appropriate actions.

In the case of automated allocation, the job dispatcher 21 can select another mobile worker 20 from a list of suggested mobile workers provided by the central server 12. In the event that no mobile workers 20 are available to take the job booking, the Job Allocation Subsystem 52 can be configured to automatically suggest a different time, and one or more mobile workers 20 who are able to take the job booking at that different time to the job dispatcher 21. Alternatively, if the new job booking is urgent or the relevant customer 40 is a regular customer, the Job Allocation Subsystem 52 may be configured to determine an existing, less urgent job booking of a mobile worker 20 that can be moved to another time so as to accommodate the new job booking.

Once a job booking is accepted by a mobile worker 20 using their device 22, a confirmation message is automatically sent to the job dispatcher 21 via computer 26, and to the customer 40 to notify the customer 40 of the expected booking time. The confirmation message to the customer 40 may be in the form of an email, text message, or automated phone call. Where appropriate, the Job Allocation Subsystem 52 may calculate an estimated cost for that job booking based on jobs recorded in the database, and send the estimated cost to the customer 40 after approval by the job dispatcher 21 or mobile worker 20 via their respective computer 26 or device 22.

Diary Management Subsystem 54

The Diary Management Subsystem 54 at the central server 12 provides an interface to schedule a job booking or event in a diary associated with a mobile worker 20, or any other staff members at the office. The diary displays a range of dates, and jobs (if any) that have been booked at a specific date and time. For each job, the contact details of the customer and other information of the job is also accessible via the mobile communication device 22 or the office computer 26.

Events can be scheduled in advance, and the time allocated to that job booking or event will be blocked out in the diary. As these are entered into the diary, the time is reserved, and users or authorised contacts are able to view their commitments to ensure times are not double booked. If the Job Allocation Subsystem 52 is configured to perform automatic job allocation, the diary of a mobile worker 20 is also automatically accessed to determine whether the mobile worker 20 is available to take the new job.

Each mobile worker 20 can also allow certain contacts or other users to view their diary using a mobile communication device 22 or office computer 26, which can be configured in the Contact Management Subsystem 66. When giving permission to view the diary, some contacts will be allowed to see the appointment details, whereas others will only be allowed to see what times are already booked and therefore what times are available.

If the person viewing the diary wishes to select a time that is already booked, the booked times will be shaded, however job booking details will only be shown if that person is authorised to see them. The person viewing the diary will still be able to request a pre-booked time but will be advised that confirmation is necessary, as the job dispatcher 21 or mobile worker 20 may want to re-schedule the original job booking to make time for the new request. If a job booking is re-scheduled, the customer 40 will be contacted via SMS or e-mail, either automatically by the central server 12 or manually by the job dispatcher 21.

Users are also able to view another user's diary to coordinate an appointment time. For example, two or more mobile workers may arrange a time to arrive at a customer's site together to complete a job. This feature is particularly useful if all parties use the same system and could view (and synchronise) each other's diary. Once the time is agreed, it will be confirmed in each diary and if necessary reminders can be set using the Event or Reminder Appointment Subsystem 66.

As a job booking is made, a message will be sent to the mobile worker's 20 mobile communication device 22 immediately via the mobile communication network 34 if the job booking is for the same day. Alternatively, it will be scheduled for view at another time, either manually or automatically. If the appointment is accepted, the central server 12 will send a standard confirmation e-mail or SMS back to the user who initiates the booking using the contact details of that user as maintained by the Contact Management Subsystem 66. If the mobile communication device 22 does not have any Internet access, the central server 12 will send a SMS message instead.

Job Management Subsystem 56

The Job Management Subsystem 56 at the central server 12 enables an authorised user to book and manage jobs via a web interface provided by a mobile communication device 22 or computer 26. When on the road, a mobile worker 20 will be able to view their jobs for the day as recorded in their diary or job list, including name of the customer, address, and other relevant details that comprise a job record. If the mobile worker 20 is running late, the Job Management Subsystem 52 can be configured using the mobile communication device 22 or office computer 26 to notify one or more subsequent customers 40 of the delay.

As a mobile worker 20 is performing a job, the Job Management Subsystem 56 provides an interface to enter start and end times of the job; travel time; expenses incurred (if the job requires replacement of parts); and penalty rate such as for after-hours jobs. Once a job is completed, the mobile worker 20 can update the job status stored in the database as ‘Completed’ via their mobile communication device 22

All payments will be recorded against a job as each job is completed. Once a job status is updated as ‘Completed’, the mobile worker 20 can use the Job Management Subsystem 56 to automatically calculate a bill or invoice by simply pressing a payment button on the mobile payment terminal 52. The mobile worker 20 will then be presented with five options, being ‘Cash’, ‘Credit Card’, ‘Debit Card’, ‘EFTPOS’ and Invoice.

If either ‘Credit’ or ‘Debit’ is selected, the mobile worker 20 will be prompted to swipe the customer's 40 card through the mobile payment terminal 24, which encrypts payment information of the credit or debit card as soon as the card is swiped. The payment information includes Track 2 data such as the card number of the credit or debit card. For credit card transactions, Track 2 of the credit card is encrypted by the mobile payment terminal 24 using Triple DES encryption, and the encrypted Track 2 data is sent to the mobile communication device 22 via Bluetooth. The software application on the mobile communication device 22 allows the Card Verification Value (CVV) on the customer's 40 card to be entered for additional confirmation that the card is present during the transaction.

For bank debit cards, Track 2 is encrypted, but the customer is also prompted to enter their PIN for additional security, and select either ‘Savings’ or ‘Cheque’ account. The encrypted information is then sent by the mobile payment terminal 24 to the mobile communication device 22 using wireless protocol such as Bluetooth. The payment information is encrypted using Triple DES standards, and the mobile communication device 22 is also running a SSL system to provide two levels of encryption.

The Job Management Subsystem 56 is designed to comply with Payment Card Industry Data Security Standards (PCIDSS) and Eurocard MasterCard Visa (EMV). The credit card and bank account numbers are not stored by the central server 12 at any time either during payment processing or after. The only details that are stored are the receipt number, as seen on the customer's credit card statement, and part of the credit card number. For example, a credit card number may be represented as 1234 XXXX XXXX XX09. Advantageously, using the mobile payment terminal 24, the card details do not have to be manually entered by the mobile worker 20 or another authorised user 21 at the office, thereby reducing the risk of the credit card number being stolen. This is also the case if the mobile payment terminal 24 is integrated with a mobile communication device 22 to form an integrated mobile device 23.

The mobile communication device 22 then sends the encrypted payment information, and information identifying the job associated with the payment (such as a job identifier of a job record in the database), to the central server 12 for processing. The central server 12, which is situated behind a secure firewall to protect cardholder data then proceeds to decrypt the received encrypted payment information. Then based on the decrypted payment information, the central server 12 requests approval of the payment from the payment gateway 13 in real time. The transaction will be processed by the secure payment gateway 13 by sending it to the relevant financial institution 30 in real time for approval.

Business Cashbook Subsystem 58

If approval is received from the secure payment gateway 13, the Business Cashbook Subsystem 58 at the central server 12 will automatically record the payment in an accounting system in the form of cashbook associated with the job or mobile worker 20, and update the payment status of that job in the database as ‘Paid’. Only the payment amount and customer details, but not the credit or bank card number, will be stored in the database 14.

A payment confirmation message which outlines a Transaction Code and an Audit Number associated with the payment will be returned to the mobile communication device 22 and recorded by the central server 12 with the job record. The mobile worker 20 is then prompted to send a receipt, and is able to select the receipt printer, SMS, or e-mail. If a signature is required, the customer 40 is asked to sign the first receipt (which the mobile worker 20 keeps) and a second receipt is printed for the customer 40. Some PDAs that cater for on screen signature capture can also be used.

The Business Cashbook Subsystem 58 is built around a general ledger system with standard allocation codes pre-configured. These codes cannot be modified by a user, but the label connected to each code is user-customisable. When an account is set-up, a user (such as a mobile worker 20) can configure the Business Cashbook Subsystem 58 by labelling each pre-configured code with terms that have some meaning and relevance to the users, to make it easier for users to allocate revenue, supplies, expenses and overheads into the correct location in the general ledger.

As expenses are paid for by the mobile worker 20 or company, they can also be entered into the cashbook using a computer 26 or on a mobile communication device 22. Expenses that are to be applied to a specific job will require the user to select the job from a list as the expense is entered, and the user may attach notes if required. If the user is not sure, they can select an “Unassigned” or “I Don't Know” button when recording expenses or receipts, then enter a note or reference. This allocation will be placed into a separate location rather than posting it to the wrong job or general ledger account. The expenses can be correctly allocated at a later time.

At the end of an accounting period (usually at the end of the month), a bookkeeper can automatically retrieve the payments and expenses entered in the cashbook. The Business Cashbook Subsystem 58 may integrate with other third-party software that provide more accounting functionality. For example, accounting data in the cashbook can then be imported into third-party accounting system such as MYOB or NetSuite, for example, in real time or via a daily batch process at the end of every working day. The cash book provides the necessary functionality to complete annual returns and Business Activity Statements (BAS). The Business Cashbook Subsystem 58 can also be scheduled to perform automatic checks on the cashbook associated with each mobile worker 20 to ensure that performed jobs have been paid.

Accounts Management Subsystem 60

An administrator 21 is able to configure links to as many bank accounts as they wish using a main subscriber configuration menu provided by the Accounts Management Subsystem 60 at the central server. The Accounts Management Subsystem 58 can be configured to calculate how available funds should be dispersed as they are received, and authorised users can use this information to transfer funds between accounts to assist with cash flow management. This can be used to ensure the necessary funds are available when it comes time to pay business expenses, supplier invoices, GST, wages, etc. A separate budget can also be configured for personal expenses, mortgage or loans, credit cards, school fees, and personal taxes.

Vehicle Log Book Management Subsystem 62

The Vehicle Log Book Management Subsystem 62 allows a mobile worker 20 to record odometer readings via the mobile communication device 22 or office computer 26. When a mobile worker 20 goes to their vehicle in the morning, they will be asked for the odometer reading before they get the details of the first job. When each job is completed, the mobile worker 20 will be asked for the odometer reading before getting the next job, so the vehicle log book is kept up to date. If required, a reminder can be sent to the mobile communication device 22 at the beginning of the day, and as each job is either accepted or completed. This can be configured in the user profile by an administrator 21.

Contact Management Subsystem 64

The Contact Management Subsystem 64 records the contact details of each authorised user, supplier and customer. The contact details may also include personal details such as birthdays, family names, interests and sporting preferences. These are all optional fields that each user can record data into if they want to store that type of information. It is expected that some users will want to store more information than others, and the amount of information stored will vary from one contact to the next.

Using the Contact Management Subsystem 64, all authorised user and supplier transaction details including quotes, invoices, purchase order details, payments and general notes are associated with the respective authorised user or supplier's record in the database 14, with the date and time of each transaction and a link to the Diary associated with a mobile worker 20. This link enables a user, such as a job dispatcher 21, to search by date (e.g. to list all jobs completed on a set date or range of dates), or scroll through a month to locate a record, transaction or payment if required.

A number of standard reports are to be incorporated into the system, and the Administration Manager can customise additional reports if required. Personal contacts such as relatives, friends and other associates can also be recorded in the same manner.

A “Primary Contact” option can be set for each supplier or customer if required, to link a number of contacts to a primary contact. For example, a primary contact would be the building management company or body corporate, and their details can be entered using the Contact Management system. The tenant's details can then be recorded in a separate record in the database, but linked to the Primary Contact. This enables a contact list to be generated and printed as a report with each name, address and phone number. This report can be provided to the field staff, attached to an e-mail or imported and merged into a standard letter.

Event or Appointment Reminder Subsystem 66

A feature of the Event or Appointment Reminder Subsystem 54 is the ability to set a reminder for events recorded in an authorised user's diary. Reminders will send a message to an authorised user for any event such as a meeting, job booking and personal appointments. Reminders can be sent via SMS to a mobile communication device 22 or via e-mail to a computer 22, or to multiple mobile devices 22 and computers 26.

If required multiple reminders can be set for an appointment and notes can be attached to each reminder. The reminder could be to perform a specific task a month or more in advance of the appointment date, then another reminder a week in advance, and the day before.

The Event or Appointment Reminder Subsystem 66 can be set up to send a different message to each user or contact linked to a job booking to remind them to perform a task, such as send a letter or invoice, review inventory and place a purchase order, or prepare a presentation or proposal. Each person could have a separate reminder message attached to their reminder if required.

Reminders for regular maintenance tasks such as those included within a maintenance contract can also be set. For example, a mobile worker 20 may have a contract to perform preventative maintenance on fire sprinkler systems or air conditioning systems within a building every six months. A month in advance, the mobile worker 20 may wish to notify all the tenants in the building by mail. Another reminder could be set using the Event or Appointment Reminder Subsystem 66 to phone each tenant to arrange access, and to order the materials required to complete the job. A final reminder could be set to confirm a time with the building supervisor and collect the materials ordered a week prior.

Other Settings

Users can customise the e-mail service so that only e-mails from certain people are forwarded to the mobile communication device 22 to minimise unnecessary mobile data download and upload costs and inbox clutter. The central server 12 can also hold attachments to e-mails until the user reviews the e-mails and requests the attachment to be forwarded to the mobile communication device 22. The interface to the central server 12 can also be configured to provide a list of supplier name and when a name is clicked, a website associated with the supplier will be automatically accessed.

Workflow

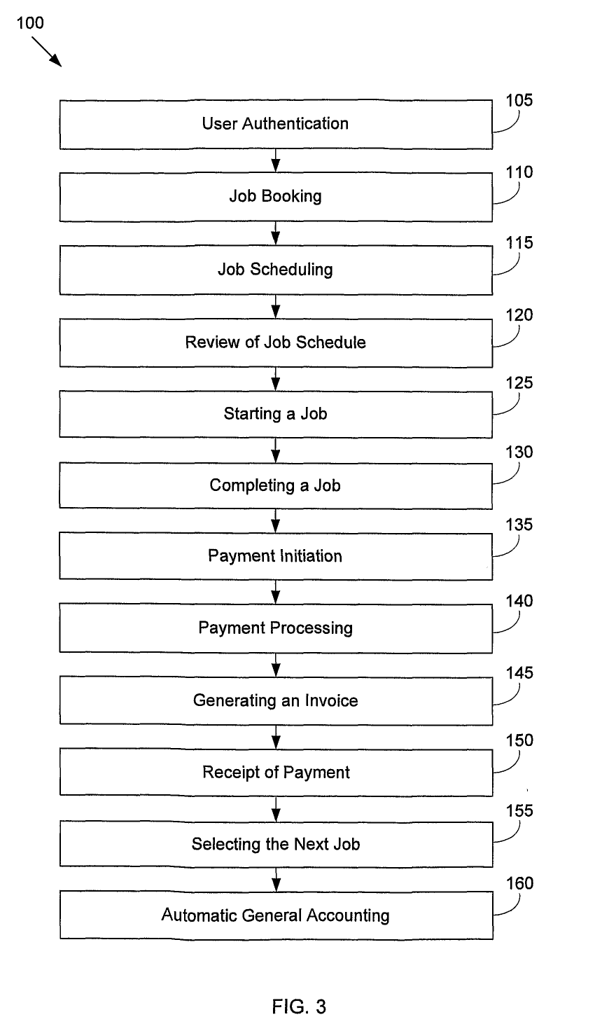

An exemplary workflow of the invention when in use will now be explained with reference to FIG. 3.

User Authentication 105

At the beginning of each day, job dispatchers 21 and mobile workers 20 will be required to log in and enter their password to gain access to the central server 12. Depending on the configuration of the account, a mobile worker 20 may be required to enter their odometer reading for their vehicle log book using the Vehicle Log Book Management Subsystem 62. Once logged in, they will have access to job information and other functionality depending on the permissions set for the user.

An authentication smart card may also be provided to all users. This feature is an optional feature that is configurable by an administrator. If this feature is used, each user will be required to insert their smart card into a card reader before they log in. If the smart card is not available, they will not be logged in and therefore will not have access to their account until authentication has been confirmed. A low cost card reader will be provided for computer access, whereas mobile workers 20 using their mobile communication device 22 can use the associated mobile payment terminal 24 to swipe their smart card. Once a user has been authenticated, all operations from that point forward are performed within a Secure Socket Layer (SSL) or similar encryption session for added security.

Job Booking 110

A job can be scheduled using the Job Allocation Subsystem 52 at the central server 12 via either a computer 26 or a mobile communication device 22 associated with the mobile worker. If the job is booked from the computer 26, it can be seen on the mobile communication device 22 after the associated mobile worker 20 has logged in. A job can be booked for the current day or scheduled for another day.

If manual allocation is selected, the user can access the diary for the mobile worker 20 to avoid scheduling jobs that either clash time wise or are not practical due to distance from the previous job. In the case of a job dispatcher 21 who schedules jobs for multiple mobile workers 20, they will be able to see the diary of each mobile worker 20 that they are managing jobs for.

If the Job Allocation Subsystem 52 is configured to perform automatic allocation, the Subsystem 52 will automatically access the diary of the mobile workers 20 to determine one or more workers 20 who are suitable for the job based on the search criteria set by the dispatcher 21.

Job Scheduling 115

A job dispatcher 21 will have access to a list of jobs and appointments for each mobile worker 20 in the database 14. The job list will be automatically downloaded into the mobile communication device 22 as soon as the mobile worker 20 has been authenticated. The mobile worker 20 would typically only want to review all of their jobs for the current day, therefore the current day's jobs will be displayed as soon as they log in as the first screen.

Review of Job Schedule 120

Once the mobile worker 20 has logged in, they will be able to see all jobs for the day, and re-schedule as required, using the Job Management Subsystem 56 and Diary Management Subsystem 54. They will also be able to review the job list for any other day as required. Each mobile worker 20 will be able to review and manage their jobs via their mobile communication device 22 or via a computer 26 with a browser interface.

Starting a Job 125

To start a job, the mobile worker 20 will enter the start date and time and perform whatever tasks are required to complete the job at a customer's premises 40 using the Job Management Subsystem 56. If travel time is charged to the customer 40, the mobile worker 20 will be able to record the time as a separate line item in the receipt or invoice if required. If the price has already been quoted, the details and price information will be shown. If additional work or parts are required, they may be added upon completion.

Completing a Job 130

To complete a job, the mobile worker 20 will update the job as ‘Completed’ using the Job Management Subsystem 56 via their mobile communication device 22. If required, they can also access the job record on their computer 26, or have an authorised user 21 access the job record on their behalf. For example, if a large number of parts and labour needs to be added to an invoice, it may be easier to enter the information into the job record on a computer 26 via the browser interface rather than on a phone or PDA 22. If the details are entered via a computer 26, they will be sent to the mobile phone or PDA 22 for job completion and payment collection. This will allow a non-computer savvy mobile worker 20 to call their office and get another authorised user 21 to enter the details, and then send them the completed job details back to them so that they can complete the payment process. In some cases where a job for an account customer could be performed, the completion of the job will trigger the invoice to be sent immediately by the central server 12 via email or standard mail.

Payment Initiation 135

Once the final amount is calculated by the Job Management Subsystem 56, the central server 12 will cause the mobile communication device 22 to display a draft invoice with that amount. The central server 12 also provides an interface through the mobile communication device 22 for the mobile worker 20 to manually alter the amount.

The mobile worker 20 will then be prompted to select the payment method, which will be either ‘Cash’, ‘Cheque’, ‘Credit Card’, ‘Debit Card (savings or cheque)’ or ‘Invoice’. Cash will be recorded as a cash payment, and a receipt can be printed, emailed, faxed or sent via SMS text message to the customer 40. If a credit or debit card is used, the mobile payment terminal 24 will automatically encrypt payment information comprising the card number and send the encrypted payment information to the mobile communication device 22, which in turns sends it to the central server 12 for approval. The mobile communication device 22 also sends information identifying the job associated with the payment information to the central server 12.

Payment Processing 140

At the central server, the encrypted payment information is decrypted by the server 12. Based on the decrypted payment information, the server will request approval from a financial institution 30 associated with the debit or credit card via the secure payment gateway 13. The financial institution 30 will then respond with either ‘Accept’ or ‘Decline’ and an audit code for that transaction. All transaction details are recorded in the database regardless of the status to provide an accurate audit trail of all attempted and completed transactions.

The response and audit code is sent back to the mobile communication device 22. If the payment has been declined, the mobile worker 20 will need to process payment via another card or method. If the payment is approved, the central server 12 will update the accounting system associated with the mobile worker 20 with the payment to reflect the approved payment. Based on information identifying the job associated with the payment, the central server 12 will also update the payment status of the job as ‘Paid’ in the database and generate a receipt for that payment. Receipts can be sent via email, fax or SMS Text, or mailed if preferred by the mobile communication device 22 or central server 12.

A customer 40 can choose to authorise a direct debit payment from a specific bank account, buy providing their BSB and Account number rather than a credit card. In this case, the direct debit file is created and processed, such as each business day. The direct debit process also provides reconciliation data as each transaction is processed.

Generating an Invoice 145

If the job is to be invoiced, the details can be entered via the mobile communication device 22. Alternatively, the mobile worker 20 could call the office to have another person 21 complete the job using a computer interface 26. Once the details are entered, the invoice can be emailed, sent via fax, or printed and sent via post to the customer 40. If an invoice has been sent, the job will remain open until payment has been receipted. Reminders in the form of a reminder email or text message can be set up to remind the mobile worker 20 or administrator 21 to chase up any outstanding payments and complete the jobs as the payments are receipted.

Receipt of Payment 150

If immediate payment is received by cash, cheque, credit card or bank debit card, the job can be completed by the mobile worker 20 using their mobile communication device 22 before they leave the site. If payment is received at a later date, the job can be completed by any authorised administrator 21 upon receipt. If a cheque bounces or a credit transaction is reversed, the job can be re-opened by the administrator 21 at any time.

A receipt can be sent to the customer 40 electronically by email, fax or SMS. Alternatively, the mobile worker 20 may have access to a mobile printer for printing receipts whilst on the road. Either way, the receipt can be printed or sent by the mobile worker 20 before leaving the site. By the time they leave the site, the paperwork associated with the payment of the job and recording the job in the cashbook of the accounting system has been completed.

Selecting the Next Job 155

Having completed a job, the mobile worker 20 could then view or select the next job using the Job Management Subsystem 52. In some cases, the mobile worker 20 will be prompted to enter their odometer reading using the Vehicle Log Book Management Subsystem 62 before starting the next job so as to keep their vehicle log book up to date for tax purposes. This feature can be disabled by the administrator 21 if it is not required. The next job can then be viewed, and the start time recorded before proceeding.

Automatic General Accounting 160

Once the receipt has been sent, a job can be closed. At that point, all the details of the job are sent to the business cashbook and recorded so that the accounts can be completed at the end of the month by the bookkeeper or accountant using the Business Cashbook Management Subsystem 58 and Accounts Management Subsystem 60. If the business uses third party accounting software such as MYOB, they will be able to download the details into their system and complete the accounting accordingly. For small businesses, the bookkeeper is usually be the partner or wife, however if a third party bookkeeper has been configured, they will be able to log into the system via a browser interface to do the accounts at the end of the month (or as frequently as required).

An ‘Unassigned’ or ‘I don't know’ category is available for all payments and expense receipts made where the mobile worker or administrator is not sure what general ledger account to allocate it to. Anything that is not allocated will be dropped into the ‘Unassigned’ category until somebody who does know (eg bookkeeper or accountant) is available to correctly allocate it, thereby avoiding unnecessary problems. Any job that has been completed can be recalled by entering the job or invoice number, or entering the last four digits of the customer's credit card and the audit code. This functionality will only be available to users with administrator access, and only available via the computer browser 26.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A mobile business system comprising:
a database to record one or more mobile workers, where each mobile worker is associated with one or more jobs;
a server in communication with a mobile communication device associated with a mobile worker and operable to:
receive encrypted payment information associated with a job from the mobile communication device;
decrypt the received encrypted payment information and based on the decrypted payment information, request approval of payment from an external server;
and if approval is received, automatically update an accounting system associated with the mobile worker with the payment to reflect the approved payment, update status of the job associated with the payment information in the database and send a payment confirmation message to the mobile communication device.

2. A mobile business system according to claim 1, wherein payment information of a debit or credit card is encrypted by a mobile payment terminal before it is received.

3. A mobile business system according to claim 2, wherein the mobile payment terminal is integrated with the mobile communication device.

4. A mobile business system according to claim 2, wherein the mobile payment terminal is in wireless communication with the mobile communication device, and both the mobile payment terminal and the mobile communication device are running an encryption session when the encrypted payment information is sent from the mobile payment terminal to the mobile communication device.

5. A mobile business system according to claim 2, wherein the payment information includes a card number of the debit or credit card that is not stored by the server when requesting approval from the external server.

6. A mobile business system according to claim 1, wherein the server updates the accounting system with the payment by determining a payment amount from the decrypted payment information and recording the payment amount in a cashbook associated with the mobile worker.

7. A mobile business system according to claim 1, wherein the server is operable to receive information identifying a job associated with the payment information from the mobile communication device, and if approval is received from the external server, to update the status of the job in the database based on the received information.

8. A mobile business system according to claim 1, wherein the database further stores one or more diaries that are each associated with a mobile worker, and the server is further operable to provide an interface to add a job to a diary associated with a mobile worker.

9. A mobile business system according to claim 1, wherein the server is further operable to access details of a job, and based on the details and user-determined search criteria, to automatically search a diary of one or more mobile workers to find a mobile worker who satisfies the user-determined search criteria.

10. A mobile business system according to claim 8, wherein the user-determined search criteria comprises one or more of:
availability of a mobile worker;
skill level of a mobile worker and nature of the job;
location of a customer associated with the job;
location of a mobile worker; and
previous experience of a mobile worker with a customer associated with the job.

11. A mobile business system according to claim 8, wherein when a job is added to the diary associated with a mobile worker, the server is operable to send a message to the mobile communication device associated with the mobile worker to either accept or reject the job.

12. A mobile business system according to claim 8, wherein the details of a job are automatically extracted by the server from an electronic message from a customer.

13. A mobile business system according to claim 1, wherein the server is further operable to calculate an estimated cost for a job based on details of that job and jobs recorded in the database.

14. A mobile business system according to claim 1, wherein the server is further operable to:
provide an interface for a mobile worker to enter one or more of the following information: start time, end time and expenses incurred for a job; and
based on the entered information, automatically calculate a payment amount and prepare an invoice for that payment amount.

15. A mobile business system according to claim 1, wherein the server is further operable to record expenses associated with a job, and business overheads in the accounting system.

16. A mobile business system according to claim 1, wherein the server is further operable to perform scheduled checks on the accounting system associated with one or more mobile workers to ensure that jobs have been paid.

17. A mobile business system according to claim 1, wherein the server is operable to send a reminder message about a job at a specified date and time to the mobile communication device of a mobile worker, or to a computer associated with a customer.

18. A mobile business system according to claim 1, wherein the server is further operable to provide a vehicle log book interface for a mobile worker to enter and update an odometer reading.

19. A mobile business system according to claim 1, wherein the server is further operable to provide an interface to download data from the database and/or the accounting system associated with a mobile worker to third-party accounting or customer relationship management software.

20. A mobile business system according to claim 1, wherein when the approval for a payment is received, the server is further operable to automatically prepare and send a receipt for that payment to a customer.

21. A mobile business system according to claim 2, wherein the server decrypts the received encrypted payment information behind a secure firewall to protect a card number of the debit or credit card.

22. A computer program to implement the system according to claim 1.

23. A method of facilitat a mobile business, wherein with plural mobile communication devices are each associated with a mobile worker, the method comprising:
receiving encrypted payment information associated with a job from a mobile communication device of a mobile worker;
decrypting the received encrypted payment information and based on the decrypted payment information, requesting approval;
and if approval is received, automatically updating an accounting system associated with the mobile worker with the payment to reflect the approved payment, updating the status of the job associated with the payment information and sending a payment confirmation message to the mobile communication device.

24. A method operating at a mobile communication device to facilitate a mobile business, wherein the mobile communication device is associated with a mobile worker, the method comprising:
receiving encrypted payment information from a mobile payment terminal associated with the mobile communication device;
sending the encrypted payment information and information identifying a job associated with the encrypted payment information for approval of payment;
and if approved, receiving and displaying a payment confirmation message that the payment has been approved and an accounting system associated with the mobile worker is updated with the payment to reflect the approved payment.
